(19) United States
(12) Patent Application Publication
(10) Pub. No.: US 2003/0002834 A1
(43) Pub. Date: Jan. 2, 2003

(54) Low loss isotopic optical waveguides

(76) Inventors: Thomas G. Brown, Rochester, NY (US); Bland A. Painter III, Troutville, VA (US)

Correspondence Address: Sam Pasternack, Ph.D., Choate, Hall & Stewart, Exchange Place, 53 State Street, Boston, MA, 02109, US

(21) Appl. No.: 10/068,746

(22) Filed: Feb. 5, 2002

Related U.S. Application Data
(60) Provisional application No. 60/266,792, filed on Feb. 6, 2001.

(51) Int. Cl. G02B 6/16; G02B 6/18

(52) U.S. Cl. 385/123; 385/124; 385/142; 385/144

(57) ABSTRACT

An optical waveguide is provided. Specifically, a low loss isotopic optical waveguide that comprises a core region having a first refractive index profile by virtue of comprising a first mixture of isotopes of at least one element, and a cladding region having a second refractive index by virtue of comprising a second mixture of isotopes of said at least one element, is provided. Preferably said at least one element comprises silicon and/or oxygen. The optical waveguide may further include germania dopant in the core. A method of preparing the optical waveguide of the present invention is also provided.

### RELATED APPLICATIONS

The present application claims priority to provisional application U.S. Ser. No. 60/266,792, filed Feb. 6, 2001 which is incorporated herein by reference in its entirety.

### FIELD OF THE INVENTION

The present invention relates to optical waveguides and more particularly, to the use of isotopes in low loss optical waveguides.

### BACKGROUND OF THE INVENTION

Optical waveguides, and in particular optical fibers, have revolutionized the global telecommunications industry by dramatically increasing the “bandwidth” of communication channels (i.e., the amount of data that can be transferred along a communication channel in a given time period). However, as rapidly as optical transmission technologies have progressed, the demand for greater bandwidth, particularly in the context of the internet, has expanded even more rapidly.

The bandwidth of a communication channel is determined by the product of two terms—the speed of signal transfer along that channel and the signal capacity of that channel.

The speed of signal transfer or carrier speed along an optical communication channel depends on a number of factors that include signal dispersion and signal attenuation or loss. Signal dispersion relates to the gradual “spreading” of signals that occurs as different angular modes of a signal travel along an optical waveguide at different speeds. Signal attenuation relates to the inherent losses that occur as a signal progresses along an optical waveguide. For long distance point-to-point communication systems, the dispersion and attenuation of a signal determines the maximum possible span between regenerative repeaters (devices that correct the dispersion and amplify the signal). The latest generation optical waveguides exhibit attenuation levels that are on the order of 0.2-0.5 dB/km and require amplification every few hundred kilometers. As signals pass through these regenerative repeaters, they incur a delay that slows down their overall progress and hence decreases the carrier speed of that communication channel. As a consequence, the development of optical waveguides with even lower attenuation levels than current low loss waveguides, would dramatically increase the carrier speed of communication systems, and in particular long distance communication systems.

There are two main approaches to increasing the capacity of individual communication channels, namely time-division multiplexing (TDM) and wavelength-division multiplexing (WDM). Both involve the combination of multiple signals in a single communication channel (i.e., multiplexing). By interleaving the pulses of different signals, and thereby sharing a channel on a time basis, TDM systems take advantage of the fact that data input into optical communication systems is often slower than the peak signal carrier speed of optical channels. By transmitting signals of different wavelength in parallel, and thereby sharing a channel on a wavelength basis, WDM systems take advantage of the fact that optical waveguides can simultaneously transmit signals over a range of non overlapping wavelengths. Signal attenuation in optical waveguides is strongly wavelength dependent, and therefore the “WDM” capacity of an optical waveguide is determined in part by the range of low loss wavelengths of that particular waveguide. As a consequence, the development of optical waveguides with low attenuation levels over a wider range of optical wavelengths than in current broadband optical waveguides, would dramatically increase the channel capacity of WDM communication systems.

Since Corning Glass Company patented the first truly low loss optical fiber fabrication process in the 1970's (U.S. Pat. No. 3,932,162) numerous patents and papers have presented designs for new optical waveguides. Many of these are designed for lower loss, and others are designed for dispersion control and compensation. Still others are designed for suitable amplification and/or nonlinear optical properties.

However, there still remains a demand in the art, for communication channels of ever increasing bandwidth, and hence, a need for the development of optical waveguides with lower dispersion, lower loss and/or higher capacity.

### SUMMARY OF THE INVENTION

The present invention provides an improved optical waveguide in which the loss, dispersion and channel capacity characteristics are determined in part by the isotopic composition of the core and cladding regions of the optical waveguide.

The isotopic optical waveguide of the present invention can be incorporated into any of a variety of devices such as, for example, a single-step index optical fiber, a multi-step index optical fiber, a graded index optical fiber, a planar optical waveguide, a rectangular optical waveguide, a wavelength-division multiplexed optical communication system, a time-division multiplexed optical communication system, a soliton optical communication system, a Raman optical amplification system, an erbium doped amplification system, an ytterbium doped amplification system, or an erbium-ytterbium co-doped amplification system.

The optical waveguide of the present invention may comprise a variety of regions each having a different isotopic composition. In certain embodiments, the different regions of the optical waveguide of the present invention may be enriched for different isotopes of the same elements. In other embodiments, the different regions of the optical waveguide of the present invention may be enriched for different isotopes of different elements. Preferably the different regions of the optical waveguide of the present invention are enriched for different isotopes of the same elements. In one embodiment, the optical waveguide of the invention comprises the element silicon. In another embodiment, the optical waveguide of the invention comprises the element oxygen. In yet another embodiment, the optical waveguide of the invention comprises the elements silicon and oxygen.

In one embodiment, the optical waveguide of the present invention may comprise a region enriched for a silicon isotope (e.g., ³⁰Si). In another embodiment, the optical waveguide of the present invention may comprise a region enriched for an oxygen isotope (e.g., ¹⁸O). In yet another embodiment, the optical waveguide of the present invention may comprise a region enriched for two different silicon isotopes (e.g., ³⁰Si and ²⁹Si). In still another embodiment, the optical waveguide of the present invention may comprise a region enriched for a silicon isotope and an oxygen isotope (e.g., ³⁰Si and ¹⁸O). In another embodiment, the optical waveguide of the present invention may comprise a region enriched for two different silicon isotopes and an oxygen isotope (e.g., ³⁰Si, ²⁹Si and ¹⁸O). In certain embodiments, the optical waveguide of the present invention may comprise a region of natural abundance silica. In another embodiment, the optical waveguide of the present invention may comprise a region that has been doped with a suitable dopant, as would be known to one skilled in the art, such as germania, fluorine, erbium, or ytterbium. In one embodiment, the optical waveguide of the present invention may comprise a region that has been enriched for an isotope of silicon and/or oxygen and further doped with a suitable dopant. The present invention is not limited to silica optical waveguides or to the use of silicon and/or oxygen isotopes. In certain embodiments, the optical waveguide may be fabricated from materials other than silica such as gallium arsenide. In one embodiment, the optical waveguide of the present invention may comprise isotopes of gallium and/or arsenic.

The optical waveguide of the present invention may be divided into a variety of regions of substantially homogeneous or inhomogeneous isotopic composition. In one embodiment of the invention, the optical waveguide comprises a region having a substantially homogeneous isotopic composition wherein, the concentration of each isotopic species is substantially the same throughout said region. In another embodiment of the invention, the optical waveguide comprises a region having an inhomogeneous isotopic composition wherein, the concentration of each isotopic species varies across said region. In one embodiment, the concentration of each isotopic species varies linearly across said region. In another embodiment, the concentration of each isotopic species varies in a series of steps across said region.

In one embodiment, the optical waveguide of the present invention comprises a core region and a single cladding region, wherein the core region has a first substantially homogeneous isotopic composition, and said single cladding region has a second substantially homogeneous isotopic composition that is different from said first substantially homogeneous isotopic composition. In another embodiment, the optical waveguide of the present invention comprises a core region and a single cladding region, wherein the core region has a first substantially homogeneous isotopic composition, and said single cladding region has a first inhomogeneous isotopic composition. In yet another embodiment, the optical waveguide of the present invention comprises a core region and a single cladding region, wherein the core region has a first inhomogeneous isotopic composition, and said single cladding region has a first substantially homogeneous isotopic composition. In still another embodiment, the optical waveguide of the present invention comprises a core region and a single cladding region, wherein the core region has a first inhomogeneous isotopic composition, and said single cladding region has a second inhomogeneous isotopic composition that is different from said first inhomogeneous isotopic composition.

In one embodiment, the optical waveguide of the invention comprises a core region and at least two cladding regions, wherein the core region and at least two cladding regions have substantially different isotopic compositions. In one embodiment the core region and at least two cladding regions are comprised of substantially homogeneous isotopic compositions. In another embodiment, one or more of said core region and at least two cladding regions is comprised of an inhomogeneous isotopic composition.

The present invention also provides devices selected from the group consisting of single-step index optical fibers, multi-step index optical fibers, graded index optical fibers, planar optical waveguides, rectangular optical waveguides, wavelength-division multiplexed optical communication systems, time-division multiplexed optical communication systems, soliton optical communication systems, Raman optical amplification systems, and erbium doped, ytterbium doped, or erbium-ytterbium co-doped amplification systems, that are improved over conventional devices because they incorporate the isotopic optical waveguide of the present invention.

A method of preparing the isotopic optical waveguide of the present invention is also provided comprising the step of producing a core region having a first refractive index profile by virtue of comprising a first mixture of isotopes of at least one element; and a cladding region having a second refractive index profile by virtue of comprising a second mixture of isotopes of said at least one element. In preferred embodiments, the methods of the present invention comprise a step of separating the isotopes and a step preparing the optical waveguide. According to the present invention, isotope separation is preferably performed by a method selected from the group consisting of distillation, extraction, exchange, separation, centrifugation, diffusion, chromatography, crystal growth, electrochemical methods, and electromagnetic methods. According to the present invention, preparation of the isotopic optical waveguide is preferably performed by a method selected from the group consisting of: chemical vapor deposition, molecular beam epitaxy, chemical beam epitaxy, and the “Rod-in-Tube” method. Preferably, the optical waveguide of the present invention is prepared by a chemical vapor deposition method selected from the group consisting of outside chemical vapor deposition, inside chemical vapor deposition, and axial chemical vapor deposition. In some embodiments, the steps of separating and preparing are performed separately. In alternate embodiments, the steps of separating and preparing are performed simultaneously.

### DESCRIPTION OF THE DRAWING

FIG. 1 is a graph that illustrates the signal loss per unit length of a typical silica optical waveguide as a function of optical wavelength (adapted from Optical Fiber Transmission, Indianapolis: Howard E. Sams, 1987).

FIG. 2 is a graph that illustrates the dependence of refractive index on optical wavelength for a silica material comprising a mixture of ²⁸Si and ¹⁶O, and for a silica material comprising a mixture of ³⁰Si and ¹⁸O.

FIG. 3 is a graph that illustrates the dependence of the refractive index difference between two regions of an all-silica material on the reduced mass ratio between the two regions, for optical wavelengths of 1.5, 1.6 and 1.7 μm.

FIG. 4 is a graph that illustrates the dependence of signal loss on optical wavelength for a silica material comprising a mixture of ²⁸Si and ¹⁶O, and for a silica material comprising a mixture of ³⁰Si and ¹⁸O.

FIG. 5 depicts the refractive index profile of a multi-step index optical fiber.

FIG. 6 depicts the refractive index profile of a graded index optical fiber.

FIG. 7 depicts the refractive index profile of a single-step index optical fiber.

FIG. 8 depicts the refractive index profile of a planar optical waveguide.

FIG. 9 depicts the refractive index profile of a rectangular optical waveguide.

### DESCRIPTION OF CERTAIN PREFERRED EMBODIMENTS

The present invention is directed to an isotopic optical waveguide. In particular, the invention provides an isotopic optical waveguide that has high carrier speed and high channel capacity as a consequence of having low attenuation over a wide range of optical wavelengths.

Optical waveguides are optically transparent devices, sometimes made of plastic but most often of silica, through which light can be transmitted by a series of total internal reflections. Optical waveguides such as optical fibers may, for example, comprise a core region (in which the light is guided) and a cladding region surrounding the core region in a substantially cylindrical geometry. For total internal reflection to occur at the core/cladding interface, the refractive index of the core region must exceed that of the cladding region (i.e., light must travel more slowly in the core than in the cladding).

Current low loss silica optical waveguides of core/cladding design employ a pure silica cladding and a silica core that has been doped with a small amount of germania (i.e., GeO₂). The substitution of germania for silica in the core region raises the refractive index of the core above that of the cladding by a small controllable amount. However, as is known in the art and as will be discussed below, the presence of impurities such as germania in the core guiding region of an optical waveguide also increases the light loss of that optical waveguide.

One aspect of the present invention involves the recognition that low loss optical waveguides based on a core/cladding design can be constructed by using different concentrations of silicon and/or oxygen isotopes in the core and cladding regions of an all-silica optical waveguide. Additionally, the present invention provides the first example of an optical waveguide which exhibits low loss across the 1.6 to 1.7 μm optical wavelength range.

Another aspect of the present invention involves the recognition that the use of different concentrations of silicon and/or oxygen isotopes in the core and cladding regions of a germania doped silica optical waveguide, reduces the level of germania dopant that is required in the core to obtain a given refractive index difference between the core and cladding.

Below, we discuss certain embodiments of the isotopic composition of the optical waveguide of the present invention, and the ways in which certain properties of the optical waveguide of the present invention, such as carrier speed and channel capacity, are affected by isotopic composition.

In order that certain aspects and advantages of the present invention will be more readily appreciated, we begin with a discussion of the properties of optical waveguides of a core/cladding design, with particular reference to the effects of isotopic composition on signal attenuation and refractive index.

Signal attenuation is a measure of the decay of signal strength, or loss of light power that occurs as signals in the form of light pulses propagate through the length of an optical waveguide. The amount of attenuation caused by an optical waveguide is primarily determined by its length and the wavelength of the light traveling through the waveguide. There are three major contributions to the dependence of attenuation on wavelength in optical waveguides. The first of these contributions, is absorption and scattering from extrinsic components (e.g., impurities) of the waveguide material. For example, in silica a near infrared absorption occurs at optical wavelengths of about 1.25 and 1.4 μm and is due to hydroxide ions (OH⁻) trapped in the fiber during the fabrication process. Great progress has been made in recent years to reduce this contribution. The second of these contributions is Rayleigh scattering from the intrinsic ultraviolet absorption edge. This absorption edge is due to electronic transitions and in optical waveguides made of silica, is dominated by the native SiO₂ absorption that increases dramatically below optical wavelengths of 1 μm. GeO₂, when added as a dopant to the silica core of an optical waveguide, will also contribute a small amount to this ultraviolet absorption. The third of these contributions, is an infrared absorption tail from optical phonons of the material. Since SiO₂ is a slightly polar material, in silica, mid infrared optical photons can excite vibrational states of the Si—O bonds. The largest energy phonon in conventional (i.e., natural abundance) fused silica (denoted λₚ) corresponds to a photon of wavelength 9.89 μm and the infrared absorption therefore decreases rapidly for photon wavelengths that are shorter than 9.89 μm. This decrease in absorption is however exponential in nature:

α_{IR}=7.8×10¹¹exp(−4.9019λₚ/λ) (1)

where α_{IR} is the loss due to infrared absorption and λ is the optical wavelength. As a consequence, losses due to infrared absorption extend into optical wavelengths of about 1.7 μm that are in the near-infrared region of the optical spectrum.

The overall loss in a silica material (denoted α) is therefore given by the sum of losses due to extrinsic infrared absorption (α_{OH-}), intrinsic ultraviolet electronic Rayleigh scattering (α_{Rayleigh}), and intrinsic bandtailing absorption from the infrared vibrational absorption (α_{IR}):

α=α_{OH-}+α_{Rayleigh}+α_{IR} (2)

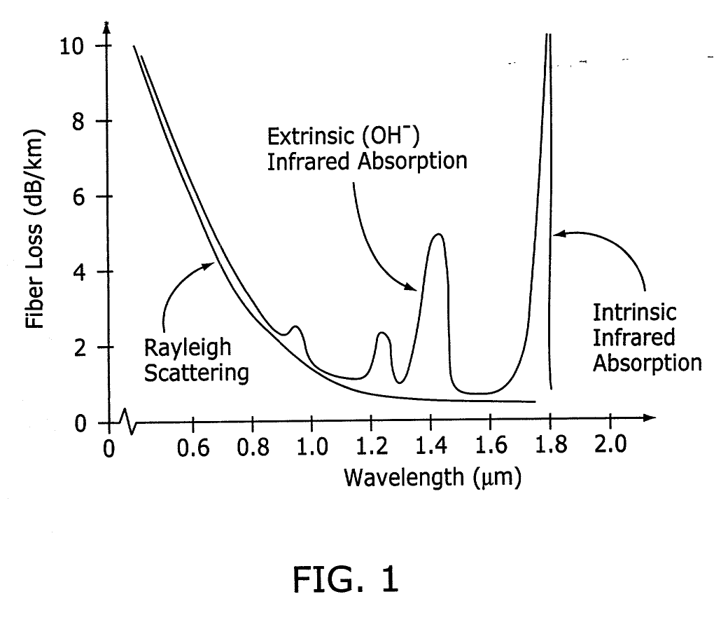

As a result of the balance between these ultraviolet and infrared contributions, silica waveguides possess a relatively narrow loss minimum which typically falls in the optical wavelength range of 1.5 to 1.6 μm. This fact is illustrated in FIG. 1 which is a schematic diagram of the loss per unit length of a typical modern silica optical waveguide.

As can be seen from Equation 1, α_{IR} shifts with the optical phonon energy λₚ of the silica material and as will be described below is therefore affected by the isotopic composition of the silica material.

The refractive index of a material is also determined by a similar balance between the infrared and ultraviolet absorptions through the Kramers-Kronig relations. The Kramers-Kronig relations are a consequence of the causal nature of optical interactions, and impose a universal relationship between the linear optical absorption spectrum and the refractive index of a material. An absorption will, in general increase the absorption across the entire optical (visible and infrared) spectrum. Such a resonance will produce a contribution to the refractive index which is positive (i.e., increases the refractive index) for wavelengths longer than the resonance, and which is negative (i.e., decreases the refractive index) for wavelengths that are shorter than the resonance.

As a rule, additional short wavelength ultraviolet absorption (i.e., shorter than 1.5 μm) and additional long wavelength infrared absorption (i.e., longer than 1.6 μm) will increase and decrease the refractive index within the low loss 1.5 to 1.6 μm communication window, respectively. Conventional fiber doping with germania increases the refractive index of the core of an optical waveguide of core/cladding design by adding additional ultraviolet absorption to the core region in the form of GeO₂ impurities. However, as was mentioned in the previous section, increased ultraviolet absorption in the form of GeO₂ also increases signal loss. As a consequence, conventional fiber doping incurs extra loss in the core guiding region of optical waveguides.

One aspect of the present invention involves the recognition that the required difference in refractive index between the core and cladding of an optical waveguide of core/cladding design can be achieved by decreasing the infrared absorption of the core region relative to the infrared absorption of the cladding region. Another aspect of the present invention involves the recognition that low loss optical waveguides based on a core/cladding design can be constructed by decreasing the infrared absorption of the core region instead of increasing the ultraviolet absorption of the core region.

It has in the past, been recognized that optical waveguides made of materials heavier than silica (e.g., fluoride materials) would provide a decrease in infrared absorption. Unfortunately, these materials are expensive, difficult to fabricate, and are not chemically compatible with the fused silica used in conventional optical waveguides.

It would therefore be of some advantage to identify a core material which is chemically compatible with conventional fused silica and yet has a lower infrared absorption than conventional fused silica. Such a material need not be as inexpensive as conventional fused silica since the core region typically makes up only a small fraction of the optical waveguide. For example, the core of a typical “single mode” optical fiber (in which the core region is significantly smaller than the cladding region) only represents about 1% of the total material volume. To put it in cost terms, a core material which is five times as costly than conventional fused silica, will increase the cost of the fiber material itself by about 4%, and will increase the total cost of the fully cabled fiber by much less than that.

One aspect of the present invention involves the recognition that one way of providing a core material with a higher refractive index than the cladding material and which is chemically identical to the cladding material, is to form the core from a mixture of silicon and/or oxygen isotopes in such a way that the infrared absorption of the core material is lower than the infrared absorption of the cladding material which is formed from a different mixture of silicon and/or oxygen isotopes.

In order that certain aspects and advantages of the present invention will be more readily appreciated, we continue with a more detailed discussion of the effects of isotopic composition on infrared absorption, and hence on the refractive index of a silica material.

The refractive index of a silica material as a function of optical wavelength in the range of 1.0 to 2.0 μm is well described by the following empirical Sellmeier formula:

$${n}^{2} = 1 + \frac{0.6961663 {λ}^{2}}{{λ}^{2} - {0.0684043}^{ 2}} + \frac{0.4079426 {λ}^{2}}{{λ}^{2} - {0.1162424}^{2}} + {\sum }_{j} {f}_{j} \frac{0.8974794 {λ}^{2}}{{λ}^{2} - {λ}_{pj}^{2}} \qquad ( 3 )$$

in which the first and second terms represent the contributions of ultraviolet absorptions (i.e., electronic transitions), the third term represents the contributions of infrared absorptions (i.e., vibrational transitions), n is the refractive index of the silica material, λ is the optical wavelength, the sum runs over all combinations of Si—O pairs (e.g., ³⁰Si—¹⁸O, ²⁹Si—¹⁸O, ²⁸Si—¹⁸O, ³⁰Si—¹⁶O, etc.), fⱼ represents the fractional concentration of the j^{th} pair within the silica material, and λₚⱼ represents the optical wavelength corresponding to the transverse phonon energy of the j^{th} pair. The separate fractions must all sum to unity

$$( i . e . , {\sum }_{j} {f}_{j} = 1 ) .$$

While the precise dependence of the phonon energy on mass is a nontrivial calculation, a good estimate can be obtained by using the model of a linear atomic chain, in which the resonance frequency ωₚⱼ of the optical phonon of the j^{th} pair is proportional to the inverse of the square root of the reduced mass μⱼ of the constituents of the j^{th} pair:

$${ω}_{pj} = c \frac{2 π}{{λ}_{pj}} = \sqrt{\frac{2 k}{{μ}_{j}}} \qquad ( 4 )$$

where c is the velocity of light in a vacuum, k is the force constant of a Si—O bond, the reduced mass μⱼ is defined as:

$${μ}_{j} = {( \frac{1}{{M}_{Si}} + \frac{1}{{M}_{O}} )}_{j}^{- 1} \qquad ( 5 )$$

where M_{Si} is the atomic mass of silicon (i.e., 30 for ³⁰Si, 29 for ²⁹Si, etc.), and M_{O} is the atomic mass of oxygen (i.e., 18 for ¹⁸O, 16 for ¹⁶O, etc.).

The difference in resonance frequency between two different regions of a silica material containing different isotope pairs will therefore be proportional to the difference in the square root of the reduced mass of each pair. For small differences in reduced mass, this is approximately proportional to one half the change in reduced mass. This is most easily expressed by differentiating Equation 4 and expressing the result as a fractional difference in resonance frequency (or resonance wavelength) as follows:

$$\frac{{Δω}_{pj}}{{ω}_{p}} = - \frac{{Δλ}_{pj}}{{λ}_{p}} = - \frac{1}{2} \frac{{Δμ}_{j}}{μ} \qquad ( 6 )$$

Because we are assuming small shifts in mass for each constituent, the denominator of each term in Equation 6 may be taken to be the mean for the silica material as a whole. This fractional difference in resonance frequency (or resonance wavelength) with mass can easily be incorporated into equations describing the difference in refractive index by differentiating the Sellmeier formula (Equation 3) with respect to the phonon wavelength λₚⱼ for each pair fraction:

$$n Δ {n}_{j} = {f}_{j} \frac{0.8974794 {λ}^{2} {λ}_{p}^{2}}{{( {λ}^{2} - {λ}_{p}^{2} )}^{2}} ( \frac{{Δλ}_{pj}}{{λ}_{p}} ) \qquad ( 7 )$$

and substituting for the fractional difference in resonance wavelength (from Equation 5):

$$n Δ {n}_{j} \approx {f}_{j} \frac{0.8974794 {λ}^{2} {λ}_{p}^{2}}{{( {λ}^{2} - {λ}_{p}^{2} )}^{2}} ( \frac{{Δμ}_{j}}{2 μ} ) \qquad ( 8 )$$

The refractive index difference for each pair may be summed over all pair combinations, yielding a total index change Δnₜₒₜₐₗ of:

$$Δ {n}_{total} \approx \frac{0.8974794 {λ}^{2} {λ}_{p}^{2}}{2 {n ( {λ}^{2} - {λ}_{p}^{2} )}^{2}} {\sum }_{j} {f}_{j} ( \frac{{Δμ}_{j}}{μ} ) \qquad ( 9 )$$

where once again the sum is over all possible combinations of isotopic mixtures. Thus, a desired refractive index difference Δnₜₒₜₐₗ between two regions of an all-silica material may be achieved by appropriate choice of isotope distributions in these regions.

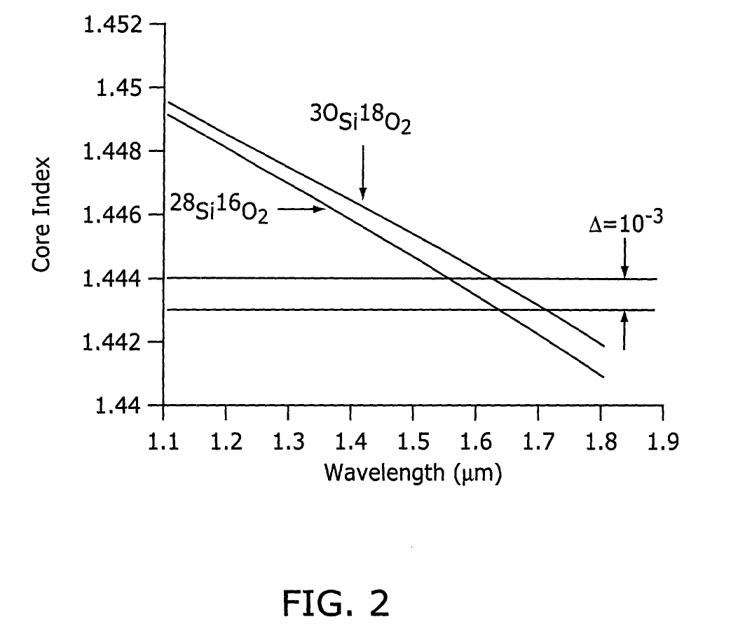

An important limitation to optical waveguide fabrication using this method is the maximum refractive index difference which may be achieved between two regions of an all-silica material through the use of isotopic mixtures. For example, if one region of a silica material is 100% enriched for the heavy isotopes of silicon and oxygen, namely ³⁰Si and ¹⁸O (i.e., a reduced mass of about 11.25), and a second region of the material comprises natural abundance silica that is rich in the lighter isotopes of silicon and oxygen, namely ²⁸Si and ¹⁶O (i.e., a reduced mass of about 10.20), then the fractional increase in reduced mass between the heavier and lighter regions is approximately 10%. By substituting this fractional increase into Equation 6, a 5% fractional increase in the maximum transverse phonon resonance wavelength is obtained between the heavier and lighter regions. As was mentioned earlier, the maximum transverse phonon resonance wavelength λₚ of natural silica that is rich in ²⁸Si and ¹⁶O is known to be about 9.89 μm. The maximum transverse phonon resonance wavelength λₚ of silica that is 100% enriched for ³⁰Si and ¹⁸O is therefore predicted to be about 10.38 μm (ie., 5% greater). Substituting these values for λₚ into the Sellmeier formula of Equation 3, yields the refractive index for each of the two regions of the material as a function of wavelength. This is illustrated in FIG. 2 which is a schematic diagram of the refractive index as a function of wavelength for the heavier and lighter regions. The difference in refractive index between the two regions of the material varies from about 500 ppm (parts per million) at lower wavelengths to about 1000 ppm at higher wavelengths.

While the core region of an optical waveguide will guide light for any refractive index that is greater than that of the cladding region, modem optical waveguide designs generally strive for a refractive index difference between the core and cladding in the range of 100 to 1000 ppm. We therefore find that it is possible, through the use of isotopic mixtures, to introduce a refractive index difference between two regions of an all-silica material which is comparable to that obtained in conventional optical waveguides with a doped core. In addition this is achieved by decreasing the infrared absorption rather than increasing the ultraviolet absorption and hence results in a lower overall loss in the optical waveguide.

While a refractive index of nearly 1000 ppm is sufficient for optical confinement of a waveguide mode, conventional optical waveguides occasionally use somewhat larger refractive index differences (e.g., between about 2000 and 10,000 ppm). In certain embodiments of the present invention, a small amount of germania may therefore be added to the core of an inventive optical waveguide to increase the refractive index difference further, while maintaining the low loss advantage offered by the isotope mixture in the core. It will be appreciated that the amount of germania dopant required will depend on the desired refractive index difference and the refractive index difference already provided by the isotopic mixture in the core. Generally speaking the addition of 1 mole percent of germania dopant increases the refractive index of silica by about 1000 ppm (for a review see, for example, Optical Fiber Transmission, Ed. by Bert Basch, Howard E. Sams & Co., Indianapolis, 1987, the contents of which are hereby incorporated by reference). Accordingly, while current optical waveguides require the addition of 2 mole percent of germania dopant to achieve a refractive index difference of about 2000 ppm between core and cladding, the current invention enables the same refractive index difference to be achieved with about half as much dopant. More generally, it will be appreciated that the current invention allows doped silica optical waveguides to be prepared that have a refractive index difference between the core and cladding regions that is greater than would be predicted simply on the basis of the mole percent of dopant that has been added to the core region. Fro example, the refractive index difference between the core and cladding regions of an inventive optical waveguide may be at least 10%, 20%, 30%, 40%, 50%, 60%, 70%, 80%, 90%, or at least 95% greater than would be predicted on the basis of the mole percent of dopant that has been added to the core region.

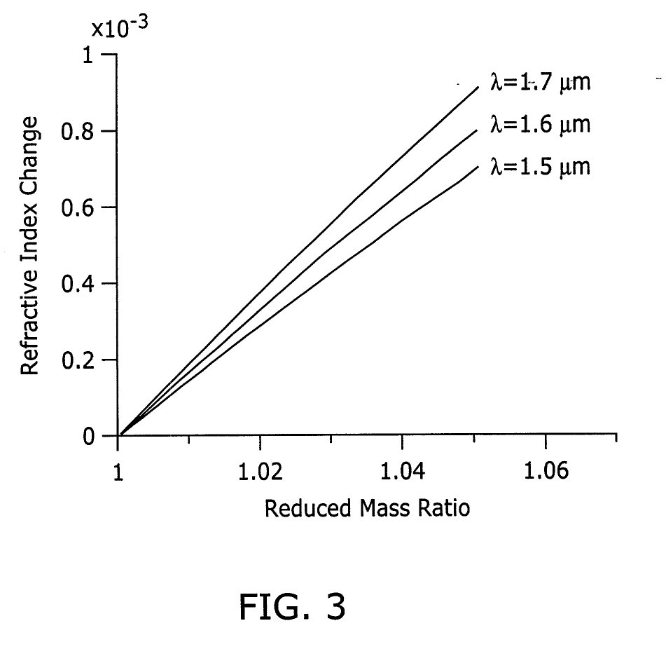

The calculations described above (i.e., Equations 1-9) are based on an optical waveguide which consists of two distinct regions, one 100% enriched for ³⁰Si and ¹⁸O and the other 100% enriched for ²⁸Si and ¹⁶O. It will be appreciated that the isotopic composition of the optical waveguide of the present invention is not limited to such an extreme example, and that a variety of intermediary isotopic compositions can be envisaged. FIG. 3 illustrates the dependence of the refractive index difference between two regions of an all-silica material on the reduced mass ratio between the two regions for optical wavelengths of 1.5, 1.6 and 1.7 μm. The refractive index of a given region of the optical waveguide of the present invention will therefore depend on the isotopic composition of that particular region and may lie anywhere between the extreme values depicted in FIG. 2.

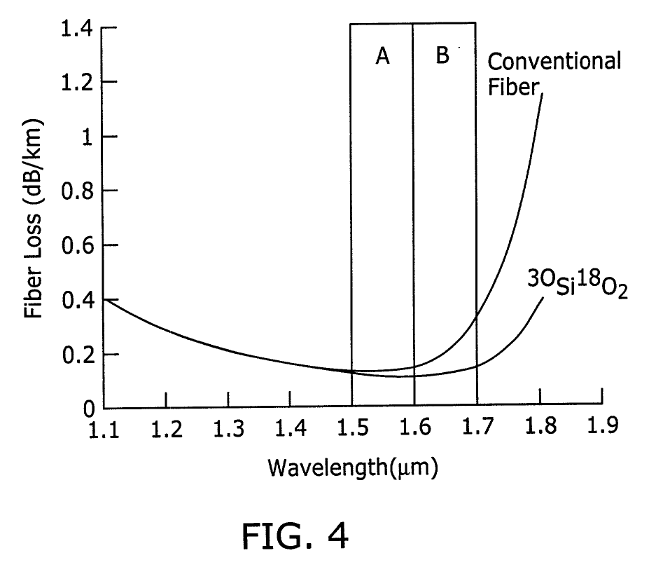

As was mentioned in the earlier section that discussed signal attenuation in optical waveguides, the overall loss in a silica material is determined by the balance between various intrinsic and extrinsic infrared and ultraviolet absorptions (Equation 2). Of particular interest is the dependence of the losses due to intrinsic infrared absorption (i.e., α_{IR}) on the transverse phonon resonance wavelength λₚ (Equation 1). As we have just described in the above section on refractive indices, the transverse phonon resonance wavelength λₚ depends on the isotopic composition of the silica material. As was calculated above, in natural abundance silica, λₚ equals about 9.89 μm, while in silica that is 100% enriched for ³⁰Si and ¹⁸O, λₚ equals about 10.38 μm. FIG. 4 illustrates the losses in these two silica materials as a function of optical wavelength, and was obtained by inserting the above values of λₚ into Equation 1 (FIG. 4 also includes the losses due to ultraviolet Rayleigh scattering (i.e., α_{Rayleigh}) that occur at lower optical wavelengths and remain relatively unaffected by isotope shifts).

The total number of wavelength channels which can be carried by an optical waveguide is determined, in a significant way, by the wavelength range over which the fiber exhibits low loss. The minimum loss requirements for optical waveguides vary with application. For long distance applications, long spans are required and the combination of low loss non-uniformity in the waveguide and gain non-uniformity at amplifier stages together may result in inferior performance for wavelength channels that are close to the edge of the low loss band. Long range terrestrial and undersea links therefore confine themselves to the low loss region between about 1.5 and 1.6 μm, labeled “A” in FIG. 4. The use of a mixture of heavy isotopes in the core as described herein results in an extended region of low loss between about 1.6 and 1.7 μm (labeled “B” in FIG. 4), approximately doubling the number of low loss wavelength channels available for optical communications. Thus, the use of isotopic mixtures in the core region of optical waveguides made according to the present invention represents a significant improvement over conventional germania doped silica cores.

In its naturally occurring form, silicon is primarily composed of three isotopes in the following abundances, 92.2% ²⁸Si, 4.7% ²⁹Si, and 3.1% ³⁰Si. In accordance with the present invention, an isotopically enriched region of ²⁸Si is a region that contains the isotope ²⁸Si in a concentration of more than 92.2% of the silicon atoms in that region. Similarly, enriched regions of ²⁹Si and ³⁰Si are regions that have atomic concentrations of these isotopes that exceed 4.7% and 3.1%, respectively. In its naturally occurring form, oxygen is primarily composed of two isotopes in the following abundances, 99.8% ¹⁶O and 0.2% ¹⁸O. In accordance with the present invention, enriched regions of ¹⁶O and ¹⁸O are regions that have atomic concentrations of these isotopes that exceed 99.8% and 0.2%, respectively.

The optical waveguide of the present invention may comprise a variety of regions each having a different isotopic composition. It will be appreciated that different regions of the optical waveguide of the present invention may also be enriched for different isotopes of different elements.

In one embodiment, the optical waveguide of the present invention may comprise a region substantially enriched for a silicon isotope (e.g., ³⁰Si). In another embodiment, the optical waveguide of the present invention may comprise a region substantially enriched for an oxygen isotope (e.g., ¹⁸O). In yet another embodiment, the optical waveguide of the present invention may comprise a region substantially enriched for two different silicon isotopes (e.g., ³⁰Si and ²⁹Si). In still another embodiment, the optical waveguide of the present invention may comprise a region substantially enriched for a silicon isotope and an oxygen isotope (e.g., ³⁰Si and ¹⁸O ). In another embodiment, the optical waveguide of the present invention may comprise a region substantially enriched for two different silicon isotopes and an oxygen isotope (e.g., ³⁰Si, ²⁹Si and ¹⁸O). In certain embodiments, the optical waveguide of the present invention may comprise a region of natural abundance silica. In another embodiment, the optical waveguide of the present invention may comprise a region that has been doped with a suitable dopant such as germania, fluorine, erbium, or ytterbium. In one embodiment, the optical waveguide of the present invention may comprise a region that has been enriched for an isotope of silicon and/or oxygen and further doped with a suitable dopant.

It will also be appreciated that the optical waveguide of the present invention may be divided into a variety of regions of substantially different or substantially similar isotopic composition, and is not limited to a simple one core, one cladding design as described in some of the above examples. Indeed, optical waveguide design necessarily includes careful determination of the core and cladding compositions, and refractive index profile in order to optimize properties such as the mode field diameter (important for coupling and compatibility between waveguides) and dispersion (important for optimizing the performance of long distance terrestrial and submarine links). These designs are often accomplished by achieving a continuous variation in refractive index within the core and cladding (i.e., “graded index profile”), in which a maximum value of refractive index in the core region decreases in a substantially continuous and smooth fashion towards the outer edge of the cladding region. A continuously varying mixture of isotopes within the core and cladding regions will accomplish such an index gradient. Modern approaches to dispersion management in optical waveguide systems often require multiple cladding designs (i.e., “multi-step index” waveguides) with a refractive index profile that involves a stepwise variation in refractive index within the core and cladding regions of the optical waveguide. The use of isotopes of varying mixtures in different cladding regions will accomplish such an index gradient, and will therefore permit the construction of, for example, dispersion shifted or dispersion flattened waveguides.

In one embodiment of the invention, the optical waveguide may comprise a region having a substantially homogeneous isotopic composition wherein, the concentration of each isotopic species is substantially the same throughout said region. In another embodiment of the invention, the optical waveguide may comprise a region having an inhomogeneous isotopic composition wherein, the concentration of each isotopic species varies across said region. In one embodiment, the concentration of each isotopic species varies in a smooth continuous fashion across said region. In another embodiment, the concentration of each isotopic species varies in a series of steps across said region.

In one embodiment, the optical waveguide of the present invention comprises a core region and a single cladding region, wherein the core region has a first substantially homogeneous isotopic composition, and said single cladding region has a second substantially homogeneous isotopic composition that is different from said first substantially homogeneous isotopic composition. In another embodiment, the optical waveguide of the present invention comprises a core region and a single cladding region, wherein the core region has a first substantially homogeneous isotopic composition, and said single cladding region has a first inhomogeneous isotopic composition. In yet another embodiment, the optical waveguide of the present invention comprises a core region and a single cladding region, wherein the core region has a first inhomogeneous isotopic composition, and said single cladding region has a first substantially homogeneous isotopic composition. In still another embodiment, the optical waveguide of the present invention comprises a core region and a single cladding region, wherein the core region has a first inhomogeneous isotopic composition, and said single cladding region has a second inhomogeneous isotopic composition that is different from said first inhomogeneous isotopic composition.

In one embodiment, the optical waveguide of the invention comprises a core region and at least two cladding regions, wherein the core region and at least two cladding regions have substantially different isotopic compositions. In one embodiment the core region and at least two cladding regions are comprised of different homogeneous isotopic compositions. In another embodiment, one or more of said core region and at least two cladding regions is comprised of an inhomogeneous isotopic composition.

### Methods of Producing an Isotopic Optical Waveguide

An isotopic optical waveguide of the present invention can be fabricated by any of a variety of methods. There are two aspects of any method of producing an isotopic optical waveguide of the present invention: i) providing separate, substantially pure isotopes; and ii) assembling the substantially pure isotopes in different regions or layers of an isotopic optical waveguide. These two aspects can be performed separately or simultaneously.

### Methods of Isotope Separation

Available methods for isotope separation include, among others, thermal gas diffusion, thermal liquid diffusion, gas centrifugation, liquid centrifugation, fractional distillation, aerodynamic separation, nozzle separation methods, chemical exchange, crystal growth, solid state separation, two phase gas-liquid exchange distillation, gas-solid separation using “zone-refining” microwave heating methods, phase transfer catalysis, gas chromatography, molecular imprinting methods, combinatorial methods, capillary zone electrophoresis, electrochemical separation, electromagnetic separation, atomic vapor laser isotope separation, laser isotope separation, and any combination thereof (see, for example, London Separation of Isotopes, London: George Newnes, Ltd., 1961; Spindel et al., J. Chem. Engin. 58, 1991; Olander, Sci. Am. 239:37, 1978; Stevenson et al., J. Am. Chem. Soc. 108:5760, 1986; Stevenson et al., Nature 323:522, 1986; Bigelelsen, Science 147:463, 1965; Tanaka et al., Nature 341:727, 1989; Ambartzumion, Applied Optics 11:354, 1972; Isenor et al., Can. J. Phys. 51:1281, 1973; Epling et al., Am. Chem. Soc. 103:1238, 1981; Kamioka et al., J. Phys. Chem. 90:5727, 1986; Lyman et al., J App. Phys. 47:595,1976; Arai et al., Appl. Phys. B53:199, 1991; Clark et al., Appl. Phys. Lett. 32:46, 1978; Lucy et al., Can. J. Chem. 77:281, 1999; the contents of each of which is incorporated herein by reference).

Examples 1-4 provide specific descriptions of fractional distillation, gas centrifugation, chemical exchange, and laser isotope separation, respectively. These examples are descriptions of certain embodiments of the present invention, and are not intended to limit the scope of the invention as a whole.

### EXAMPLE 1

### Fractional Distillation

It is well known that there exist slight differences in the heat of vaporization of different isotopic species contained in a liquid. The method of fractional distillation provides, after processing, for isotopic species to remain in the liquid phase while the other is drawn off in a vapor phase. An example of a method for the separation of silicon isotopes would be the fractional distillation of SiCl₄, a material which is liquid at room temperature but which provides a comparatively high vapor pressure. Similarly, an example of a method for the separation of oxygen isotopes would be the fractional distillation of H₂O vapor.

### EXAMPLE 2

### Gas Centrifuge

Gas centrifuge provides a method for the separation of different isotopic species by virtue of isotopic differences in mass. Silicon isotopes can be prepared, for example, by separation of SiF₄ or SiH₄ gases. Oxygen isotopes can be prepared, for example, by separation of H₂O vapor.

### EXAMPLE 3

### Chemical Exchange

Chemical exchange provides a separation between different isotopic species by virtue of isotopic differences in free energy and the corresponding influence on equilibrium chemical reactions. It has been shown that, under suitable circumstances, isotopic species will show different ratios in reactant and product mixtures for certain equilibrium reactions. The key requirements for such chemical exchange mechanisms to be effective are: the use of immiscible reactant/product phases (e.g., immiscible liquids or liquid-gas reactions), electronic orbitals similar to the delocalized orbitals found in aromatic compounds, and an appropriate catalyst to speed the reaction to equilibrium.

### EXAMPLE 4

### Laser Isotope Separation

The laser isotope separation technique relies on the fact that many molecules exhibit vibrational transitions in the near- to mid-infrared range. Bombarding molecules with radiation tuned to their vibrational transitions heats or even dissociates the molecules. Because the vibrational transitions of molecules are dependent on the masses of the atoms, molecules containing different isotopes of a given atom exhibit different transition energies. Thus, molecules containing different isotopes of a given atom are heated or dissociated by bombardment with radiation of different frequencies.

A variety of laser sources are available with access to the near- and mid-infrared region, that could be used to dissociate molecules having vibrational transitions in that region. For example, transitions in the 9-10 μm range are accessible using a CO₂ laser; various solid state lasers can access the near-infrared; and optical parametric oscillator technology can be utilized to achieve wide tunability.

In order to separate one isotope of an atom from another using laser dissociation, a mixture of molecules including the different isotopes is bombarded with radiation (i.e., from a laser) tuned to the vibrational transition frequency of a first molecule including a first isotope. The first molecule therefore becomes excited and can be separated from other molecules in the mixture by virtue of its higher temperature, or its increased sensitivity to photodissociation. After the first isotope has been isolated, the radiation frequency can be adjusted by, for example, tuning the laser to a new frequency or providing an alternate laser source, so that the radiation frequency is tuned to the vibrational transition frequency of a second molecule, including a second isotope, and that second molecule can be isolated. The procedure is repeated until all desired isotopes are isolated.

### Methods of Preparation

Methods available for preparing an isotopic optical waveguide of the present invention include, for example, chemical vapor deposition (CVD), molecular beam epitaxy (MBE), chemical beam epitaxy (CBE) and the “Rod-in-Tube” method (see, for example, Sedwick et al., J. Vac. Sci. Technol. A 10(4), 1992, incorporated herein by reference). Isotopically pure materials prepared by any available method, including those recited above, may be used in combination with standard CVD, MBE, CBE or “Rod-in-Tube” technologies to produce an isotopic optical waveguide of the present invention. Additionally, an isotopic optical waveguide of the present invention may be prepared by performing isotope separation and waveguide assembly simultaneously.

Preferred methods of preparing an isotopic optical waveguide of the present invention are CVD methods. These include outside chemical vapor deposition, inside chemical vapor deposition and axial chemical vapor deposition.

Examples 5-7 provide specific descriptions of outside chemical vapor deposition, inside chemical vapor deposition and axial chemical vapor deposition, respectively. These examples are descriptions of certain embodiments of the present invention, and are not intended to limit the scope of the invention as a whole.

### EXAMPLE 5

### Outside Chemical Vapor Deposition

The outside chemical vapor deposition process involves the deposition of raw materials onto a rotating ceramic rod. This occurs in three steps: laydown, consolidation, and draw. During the laydown step, a soot prefrom is made from ultra-pure vapors of, for example, SiCl₄. The vapors move through a traversing burner and react in the flame with oxygen to form soot particles of silica (i.e., SiO₂). When the deposition is complete, the coated rod is heated and the rod is removed leaving behind a dense and transparent consolidated silica glass preform (the ceramic rod has a lower coefficient of thermal expansion, so it separates from the preform during the heat induced expansion). At this stage the silica preform has a hole in its center where the ceramic rod used to be. The preform is then drawn into a continuous strand of glass fiber and the hole disappears.

### EXAMPLE 6

### Inside Chemical Vapor Deposition

Rather than depositing the silica soot outside a rod, the inside chemical vapor deposition process involves depositing SiO₂ soot (formed as described in Example 5) inside a fused silica tube that is then heated externally. The soot becomes the fiber's core by condensing on the inside of the tube which in turn becomes the outer cladding for the fiber.

### EXAMPLE 7

### Axial Chemical Vapor Deposition

In axial chemical vapor deposition, SiO₂ soot (formed as described in Example 5) is deposited on the outside of a pure silica rod which serves as a seed. The machinery gradually pulls back the seed rod from one end. During this pull back, the soot on the other end of the seed rod becomes the core, and the soot regions radiating outwards become the cladding.

In each of these methods, the first step involves the formation of a silica (i.e., SiO₂) soot preform. In one embodiment of the present invention, this is performed by passing precursor vapors of SiCl₄, SiF₄, SiH₄ or any other suitable source of silicon (such as, for example, other members of the halide-silane family, hydridosilicates, and organosilicon compounds) through the flame of a traversing burner in the presence of oxygen. It will be appreciated, that the isotopic composition of the different regions of the optical waveguide of the invention made according to any of the methods described in Example 5-7, or any other suitable method of optical waveguide preparation, are determined by the isotopic composition of the incoming gaseous source of silicon and/or oxygen at the time that particular region was deposited. As a consequence, it will be appreciated that by varying the isotopic composition of the incoming source of silicon source and/or oxygen at different stages of optical waveguide preparation, a variety of types of optical waveguides can be assembled. These include single-step index optical waveguides, multi-step index optical waveguides, graded index optical waveguides, and combinations thereof.

Examples 8-10 provide specific descriptions of a single-step, a multi-step and a graded index optical waveguide, respectively. These examples are descriptions of certain embodiments of the present invention, and are not intended to limit the scope of the invention as a whole.

### EXAMPLE 8

### Single-step Index Optical Waveguide

Single-step index optical waveguides comprise a core region and a single cladding region. The refractive index profile of single-step optical waveguides exhibits a discontinuity in refractive index at the core/cladding interface. When assembling a single-step index optical waveguide, a first isotopic source of silicon and/or oxygen may be used to form the core and a second different isotopic source of silicon and/or oxygen may be used to form the cladding region of the optical waveguide. Preferably the isotopic source used for the core causes the refractive index of the core to be greater than the refractive index of the cladding region. For example, a single-step index optical waveguide may be formed from a core region that has been enriched in ³⁰Si and ¹⁸O, and a cladding region made of natural abundance silica.

### EXAMPLE 9

### Multi-step Index Optical Waveguide

Multi-step index optical waveguides comprise a core region and a several cladding regions. The refractive index profile of single-step optical waveguides exhibits a series of discontinuities in refractive index at each cladding interface. When assembling a multi-step index optical waveguide, a first isotopic source of silicon and/or oxygen is used to form the core and a different isotopic source of silicon and/or oxygen is used to form each of the cladding regions of the optical waveguide. Preferably the isotopic source used in each cladding region causes the refractive index to decrease radially away from the core in a series of discrete steps, however the present invention is not limited to such designs, and in certain embodiments the change in refractive index may, for example, change sign several times as it progresses radially away from the core. In one embodiment of the present invention, the steps in refractive index between adjacent cladding regions are all substantially the same. In another embodiment of the present invention, the steps in refractive index between adjacent cladding regions are all substantially different.

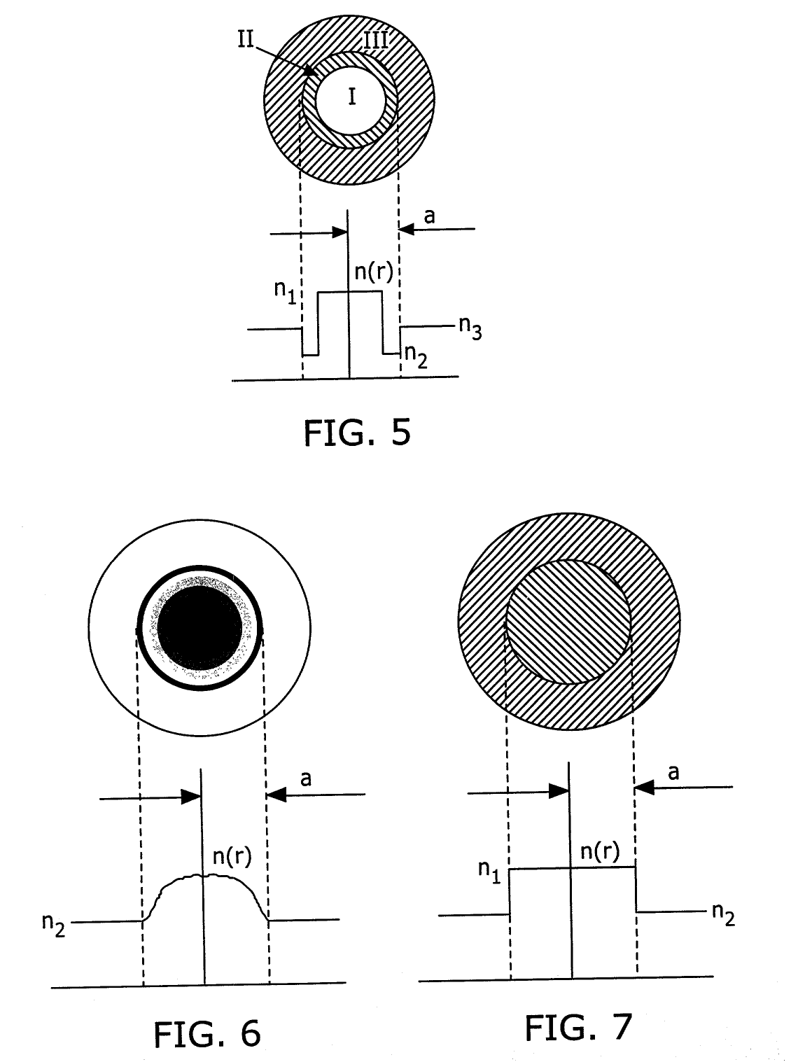

A multi-step index optical fiber may be designed for dispersion control and fabricated with multi-step index regions as shown in FIG. 5. In this example, an inner core region I is fabricated with a mixture of ³⁰Si—¹⁸O and 5% GeO₂ to produce a core refractive index of about 2000 ppm greater than the cladding region III, which is composed of fused silica of natural isotope composition. An outer core region II is fabricated with fused silica of natural isotope composition with the addition of a small amount of fluorine to lower the refractive index below that of region III. Indeed, it is known in the art that one can change the ultraviolet electronic transitions of a silica material with relatively small amounts of fluorine dopant in such a way, that the refractive index is lowered (see, for example, Sarkar, Chapter 4 of Optical Fiber Transmission, Indianapolis: Howard E. Sams, 1987).

### EXAMPLE 10

### Graded Index Optical Waveguide

Graded index optical waveguides comprise a core region and single cladding region. In certain embodiments, the refractive index profile of graded index optical waveguides made according to the present invention exhibit a discontinuity at the core/cladding interface. In other embodiments, the refractive index profile of graded index optical waveguides made according to the present invention exhibit a smooth continuous transition at the core/cladding interface. In preferred embodiments, the refractive index varies in a smooth manner within the cladding region. When assembling a graded-step index isotopic optical waveguide, a first isotopic source of silicon and/or oxygen is used to form the core and a gradually changing isotopic source of silicon and/or oxygen is used to form the cladding region of the optical waveguide. Preferably the gradually changing isotopic source used to construct the cladding region causes the refractive index to decrease radially away from the core in a smooth continuous manner, however the present invention is not limited to such a design, and in certain embodiments the gradient of refractive index change may, for example, change sign several times as it progresses radially away from the core. The refractive index may vary within the cladding region in a substantially linear manner as a consequence of the changing isotopic composition. In other embodiments, the refractive index may vary in a substantially parabolic manner. However, the present invention is not limited to particular designs and the refractive index profile may be described by any of a number of mathematical functions known in the art.

For example, a fiber with a substantially continuous refractive index gradient (FIG. 6) may be fabricated by constructing a preform using the method of outside chemical vapor deposition, in which the following four precursor gases: ³⁰SiCl₄, ²⁸SiCl₄, ¹⁸O₂, and ¹⁶O₂ are used to deposit ³⁰Si—¹⁸O, ³⁰Si—¹⁶O, ²⁸Si—¹⁸O, and ²⁸Si—¹⁶O isotope mixtures such that the heavy isotope combinations are concentrated in the inner region of the core and the lighter isotope combinations are concentrated in the outer region of the cladding.

The foregoing has provided a description of certain embodiments of the present invention, which description is not meant to be limiting. Other embodiments of the present invention that are within the scope of the claims include the following.

The optical waveguide of the invention may be any of a variety of optical waveguides as would be appreciated by one of skill in the art. For example, the optical waveguide of the present invention may be an optical fiber of substantially cylindrical geometry (see Example 8-10). In addition, the optical waveguide of the present invention may be a planar waveguide or a rectangular waveguide.

Examples 11-13 provide specific descriptions of a cylindrical step index single-mode optical fiber, a planar optical waveguide, and a rectangular optical waveguide, respectively. These examples are descriptions of certain embodiments of the present invention, and are not intended to limit the scope of the invention as a whole.

### EXAMPLE 11

### Cylindrical Step Index Single-mode Optical Fiber

If a fiber is to be used as a single-mode (i.e., supporting one mode of each polarization) step index optical fiber for a given wavelength λ, the core radius a must satisfy the following relation:

$$a < 2.405 \frac{λ}{2 π \sqrt{{n}_{1}^{2} - {n}_{2}^{2}}}$$

where n₁ and n₂ denote the refractive index of the core and cladding regions, respectively. FIG. 7 illustrates the refractive index profile of such a cylindrical single-mode step index optical fiber.

### EXAMPLE 12

### Planar Optical Waveguide

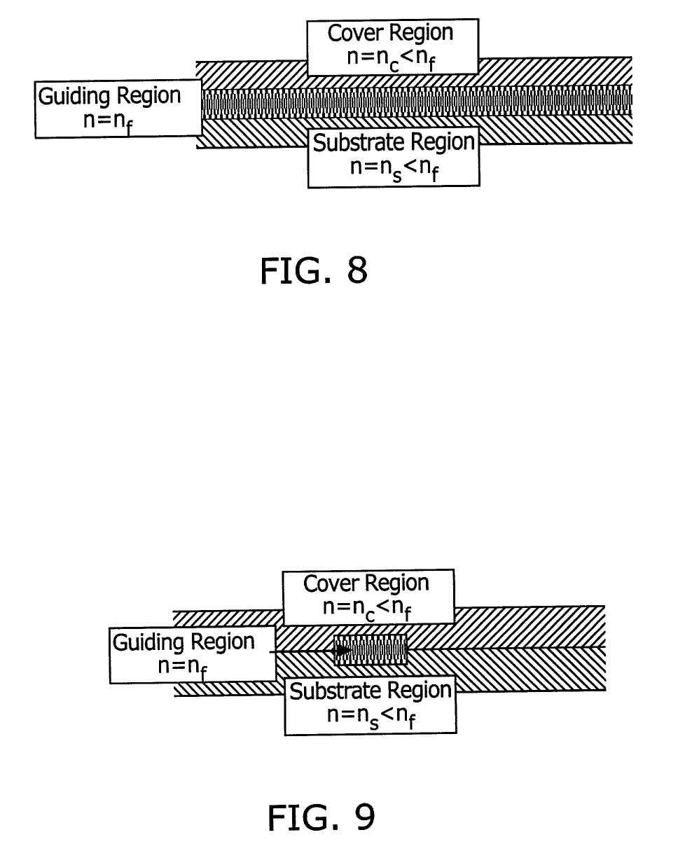

A planar waveguide, illustrated in FIG. 8, may be fabricated by the successive steps of isotope separation, preparation of isotope enriched precursor gases and chemical vapor deposition. The planar waveguide requires that at least one region (hereinafter referred to as the guiding region) possess a refractive index higher than that of the lower region (the substrate region) and also higher than that of the upper region(s) (the cover region(s)). A region of relatively high refractive index may confine light by total internal reflection in one or more propagating modes.

### EXAMPLE 13

### Rectangular Optical Waveguide

A rectangular optical waveguide, illustrated in FIG. 9, may be fabricated by the successive steps of isotope separation, preparation of isotope-enriched precursor gases and chemical vapor deposition of a guiding region followed by patterning/lithography and selective removal of regions of a guiding region, leaving a rectangular guiding region. The rectangular optical waveguide requires that the inner region (hereinafter referred to as the guiding region) possess a refractive index higher than any of the surrounding regions. A guiding region of relatively high refractive index may confine light by total internal reflection in one or more propagating modes.

As will be apparent to one of ordinary skill in the art, the present invention is not limited to silica optical waveguides that employ silicon and/or oxygen isotopes. A waveguide (cylindrical, planar, or rectangular) may be fabricated from materials other than silica. For example, a gallium arsenide (GaAs) semiconductor waveguide designed for infrared guiding may benefit from the use of a core material which comprises a heavy isotope mixture of gallium and arsenic. Semiconductor materials such as GaAs which possess infrared-active optical phonons are likely to benefit from lower vibrational absorption and provide a larger isotope-induced infrared index change than covalent semiconductors which are not infrared active.

It will also be appreciated that the optical waveguide of the invention may be incorporated into any of a variety of optical devices. For example, the optical waveguide of the present invention may be incorporated into a soliton system, a wavelength-division multiplex system, a time-division multiplex system, a Raman amplification system, or an erbium doped amplification system, in order to enhance the optical properties of those devices.

Examples 14-18 provide specific descriptions of a soliton system, a wavelength-division multiplex system, a time-division multiplex system, a Raman amplification system, and an erbium doped amplification system, respectively. These examples are descriptions of certain embodiments of the present invention, and are not intended to limit the scope of the invention as a whole.

### EXAMPLE 14

### Soliton Communication System

An optical soliton is an optical pulse which, by virtue of balancing optical nonlinearity and dispersion, propagates long distances without significant broadening of the pulse. Loss limits the choice of center wavelengths for the soliton and also limits the maximum length of a single span in a soliton communication system. The present invention may be used to improve a soliton communication system by providing an optical waveguide with lower loss in the core over a wider range of wavelengths than is used in conventional soliton communication systems.

### EXAMPLE 15

### Wavelength-division Multiplex System

The low loss optical waveguide of the present invention may be used to improve a wavelength-division multiplexed optical communication system by providing wavelength channels at longer wavelengths and at lower loss than conventional communication systems. In particular, additional channels between 1.6 μm and 1.7 μm may be added to conventional communication systems by incorporating an optical waveguide which comprises an isotope mixture, for example, in its core.

### EXAMPLE 16

### Time-division Multiplex System

Solitons, or other optical pulses, may be time-division multiplexed in a manner which is well known in the art. The present invention may be used to improve a time-division multiplexed communication system by providing a lower loss wavelength region than that used in conventional systems. The use of an isotope mixture in the core of the fiber provides a lower loss than conventional optical waveguides, in particular at wavelengths greater than about 1.6 μm.

### EXAMPLE 17

### Raman Amplification System

An incident signal of frequency ωₛ traveling down an optical waveguide may be amplified by stimulated Raman scattering if a pump laser of frequency ωₗ, differing in energy by the optical phonon energy in silica ωₚ (i.e., ω₁=ωₛ+ωₚ), is injected into the fiber using a suitable frequency selective coupler. Raman amplifiers based on optical waveguides which employ a heavy isotope mixture in the core will, because of reduced loss, allow Raman amplification in the wavelength range between 1.6 μm and 1.7 μm, significantly increasing the number of communication channels that can be amplified by these devices.

### EXAMPLE 18

### Erbium Doped Amplification System

It is well known in the art that optical waveguides doped with some hundreds of parts per million of the rare-earth element erbium (Er) in the core provide gains to an optical signal when pumped by an optical source. The erbium ion (Er³⁺) is highly absorptive when pumped by a semiconductor laser with an emission power of approximately 50-100 milliwatts at a wavelength of 0.98 μm. The excited ion decays rapidly to a metastable state, where an incoming photon at a wavelength of 1.55 μm causes decay to the ground state by the emission of a photon of identical 1.55 μm wavelength. Erbium doped amplification systems based on optical waveguides which employ a heavy isotope mixture in the core will, because of reduced loss, allow more efficient amplification for optical wavelengths greater than 1.55 μm. It will be appreciated that ytterbium (Yb) doping can be used instead of or in combination with erbium doping.

Other embodiments of the invention will be apparent to those skilled in the art from a consideration of the specification or practice of the invention disclosed herein. It is intended that the specification and examples be considered as exemplary only, with the true scope of the invention being indicated by the following claims.

What is claimed is:

1. A silica optical waveguide comprising:
a core region having a first refractive index profile by virtue of comprising a first mixture of isotopes of silicon and oxygen; and
a cladding region having a second refractive index profile by virtue of comprising a second mixture of isotopes of silicon and oxygen, wherein the first and second mixtures include different isotopic concentrations of silicon and oxygen.

2. The silica optical waveguide of claim 1, wherein:
the refractive index throughout the core region is substantially uniform;
the refractive index throughout the cladding region is substantially uniform; and
the refractive index of the core region is greater than the refractive index of the cladding region.

3. The silica optical waveguide of claim 2, wherein the cladding region consists of natural abundance silica.

4. The silica optical waveguide of claim 2, wherein the core region is enriched for ³⁰Si or ²⁹Si.

5. The silica optical waveguide of claim 2, wherein the core region is enriched for ¹⁸O.

6. The silica optical waveguide of claim 2, wherein the core region is further doped with germania.

7. The silica optical waveguide of claim 2, wherein the cladding region is further doped with fluorine.

8. The silica optical waveguide of claim 2, wherein the core region is further doped with erbium, ytterbium, or a combination thereof.

9. A wavelength-division multiplexed optical communication system comprising the silica optical waveguide of claim 1.

10. A time-division multiplexed optical communication system comprising the silica optical waveguide of claim 1.

11. A soliton optical communication system comprising the silica optical waveguide of claim 1.

12. A Raman optical amplification system comprising the silica optical waveguide of claim 1.

13. The silica optical waveguide of claim 1, wherein:
the refractive index throughout the core region is substantially uniform;
the refractive index of the cladding region is non-uniform; and
the refractive index of the core region is greater than the highest refractive index of the cladding region.

14. The silica optical waveguide of claim 13, wherein the refractive index of the cladding region decreases smoothly and monotonically with increasing distance from the boundary of the core region and the cladding region.

15. The silica optical waveguide of claim 14, wherein the refractive index of the cladding region decreases parabolically with increasing distance from the boundary of the core region and the cladding region.

16. The silica optical waveguide of claim 14, wherein the refractive index of the cladding region decreases linearly with increasing distance from the boundary of the core region and the cladding region.

17. The silica optical waveguide of claim 14, wherein the refractive index of the cladding region decreases in a series of n steps with increasing distance from the boundary of the core region and the cladding region, and n is an integer between 1 and 100.

18. The silica optical waveguide of claim 13, wherein the concentration of ³⁰Si or ²⁹Si decreases from the boundary of the core region and the cladding region to the outer edge of the cladding region.

19. The silica optical waveguide of claim 13, wherein the concentration of ¹⁸O decreases from the boundary of the core region and the cladding region to the outer edge of the cladding region.

20. The silica optical waveguide of claim 13, wherein the cladding region is further doped with germania, and the concentration of germania decreases from the boundary of the core region and the cladding region to the outer edge of the cladding region.

21. The silica optical waveguide of claim 13, wherein the cladding region is further doped with fluorine, and the concentration of fluorine increases from the boundary of the core region and the cladding region to the outer edge of the cladding region.

22. An optical waveguide comprising:
a core region having a first refractive index profile by virtue of comprising a first mixture of isotopes of at least one element; and
a cladding region having a second refractive index profile by virtue of comprising a second mixture of isotopes of said at least one element.

23. The optical waveguide of claim 22, wherein said at least one element comprises gallium, arsenic, or a combination thereof.

24. The optical waveguide of claim 23, wherein the core region is further doped with germania.

25. The optical waveguide of claim 24, wherein the cladding region is further doped with fluorine.
